(19) United States
(12) Patent Application Publication
(10) Pub. No.: US 2026/0210158 A1
(43) Pub. Date: Jul. 23, 2026

(54) SEQUENTIAL USE CYLINDER LOCK ASSEMBLY AND METHOD THEREOF

(71) Applicant: Damon E. Degre, Holden, MA (US)

(72) Inventor: Damon E. Degre, Holden, MA (US)

(21) Appl. No.: 19/033,725

(22) Filed: Jan. 22, 2025

(51) Int. Cl. E05B 27/00; E05B 35/10

(52) U.S. Cl. CPC E05B 27/0053; E05B 27/0021; E05B 35/10

(57) ABSTRACT

Lock assemblies using different keys are provided for security. In one implementation, a lock assembly includes a housing with a cylindrical channel and first and second sets of apertures extending from the cylindrical channel to an outer surface of the housing. The lock assembly also includes a sleeve with a hollow interior and multiple apertures extending from the hollow interior to an outer surface of the sleeve. The sleeve is rotatably arranged within the cylindrical channel of the housing, thereby defining a first shear line at the corresponding intersection between the sleeve and the housing. Furthermore, the lock assembly includes a plug having a keyway and a set of apertures extending from the keyway to an outer surface of the plug. The plug is rotatably arranged within the hollow interior of the sleeve, thereby defining a second shear line at the corresponding intersection between the plug and the sleeve.

### TECHNICAL FIELD

The present disclosure relates generally to mechanical security and, more particularly, to a single lock assembly where two different keys are used in sequence for unlocking in both low-security and high-security modes.

### BACKGROUND

Conventional locks and locking assemblies normally include cylinders having a single set of pins which can be moved by a key that has a particular keying pattern (e.g., notches, ridges, etc.). When the key matches the corresponding characteristics of the set of pins, the pins are aligned to permit cylinder rotation. In some embodiments, certain locks may be configured with cylinders that can lock and unlock using two different sets of keys. For example, the different sets of keys may have different keying patterns arranged 180 degrees from each other.

One use case of such locks may include the keying of one set of keys that may be given to a supervisor or building manager, while another set of keys may be given to an occupant or tenant of a particular apartment, office, etc. In one example, U.S. Pat. No. 6,314,774 (“Andersson”) allows multiple keys to unlock from either of two positions. However, it may be noted that there are certain situations where an occupant or tenant should no longer be given access to a certain apartment, office, etc., such as, for example, if the occupant or tenant has been evicted from a residence. Therefore, there is a need for a type of lock that uses two different keys, in a specific sequence, to allow two different parties to have various levels of security for access through a locked door.

### SUMMARY

The present disclosure is directed to cylinder lock assemblies and the like. In one implementations, a lock assembly includes a housing having a cylindrical channel extending therethrough, a first chamber extending from the cylindrical channel to an outer surface of the housing, and a second chamber extending from the cylindrical channel to the outer surface of the housing. The first chamber includes a first plurality of apertures, and the second chamber includes a second plurality of apertures. The lock assembly also includes a sleeve arranged within the cylindrical channel of the housing and configured to be rotatable with respect to the cylindrical channel. A first shear line is defined by an intersection between an outer surface of the sleeve and an inner surface of the cylindrical channel. Also, the sleeve further includes a hollow interior and multiple apertures extending from the hollow interior to the outer surface of the sleeve. In addition, the lock assembly includes a plug arranged in the hollow interior of the sleeve and configured to be rotatable with respect to the sleeve. A second shear line is defined by an intersection between an outer surface of the plug and an inner surface of the sleeve. The plug further includes a single keyway configured to accommodate multiple keys and a set of apertures extending from the single keyway to the outer surface of the plug. Also, the lock assembly includes a) a first set of outer pin segments arranged in the first plurality of apertures of the first chamber of the housing, b) a second set of outer pin segments arranged in the second plurality of apertures of the second chamber of the housing, and c) a set of inner pin segments arranged in the set of apertures of the plug. In a first fixed position, the set of inner pin segments are aligned with the first set of outer pin segments. In a second fixed position, the set of inner pin segments are aligned with the second set of outer pin segments. Also, in an operational range of positions, the set of inner pin segments are rotated with respect to the second set of outer pin segments to implement a locking or unlocking action.

In some embodiments, the housing may include a generally cylindrical shape, a first end, and a second end, wherein the cylindrical channel may be configured to extend from the first end of the housing to the second end of the housing. The first plurality of apertures of the first chamber may radially extend from the cylindrical channel to the outer surface of the housing. The second plurality of apertures of the second chamber may radially extend from the cylindrical channel to the outer surface of the housing. For example, in some implementations, the apertures of the first plurality of apertures may be arranged in parallel and in a planar fashion in the first chamber from the first end to the second end of the housing, and the apertures of the second plurality of apertures may be arranged in parallel and in a planar fashion in the second chamber from the first end to the second end of the housing.

According to various implementations, the multiple apertures of the sleeve may be arranged linearly from a first end of the sleeve to a second end of the sleeve. Also, the set of apertures of the plug may be arranged in parallel and in a planar fashion from a first end of the plug to a second end of the plug. In some embodiments, the lock assembly may further include a cam adapter coupled to a rear end of the plug, wherein the cam adapter may include at least one cam configured to interact with a bolt for implementing the locking or unlocking action. According to some embodiments, the cylindrical channel in the housing may be offset from a cylindrical axis of the housing, and the single keyway in the plug may be offset from a cylindrical axis of the plug.

In some embodiments, the sleeve may be rotatable within the cylindrical channel by a predetermined angular range, such as about 45 degrees. The sleeve, for example, may further include a slot configured to be engaged with a pin extending inwardly from the inner surface of the cylindrical channel of the housing, wherein physical dimensions of the slot and pin may be configured to define the predetermined angular range. The cylindrical channel of the housing, for example, may include a plurality of slanted walls, and the sleeve may include a plurality of recesses on a first end of the sleeve, wherein an interaction of the plurality of recesses and the plurality of slanted walls may be configured to limit the rotation of the sleeve.

The lock assembly described herein may further be implemented whereby the first set of outer pin segments and the set of inner pin segments may be configured in coordination with grooves cut into a blade of a control key, such that, when the control key is inserted in the single keyway, the first shear line becomes unobstructed thereby allowing the sleeve and plug to rotate with respect to the cylindrical channel between the first fixed position and the second fixed position. For example, the second set of outer pin segments and the set of inner pin segments may be configured in coordination with grooves cut into a blade of each of one or more narrow-blade keys, such that, when a key of the one or more narrow-blade keys is inserted in the single keyway, the second shear line becomes unobstructed thereby allowing the plug to rotate with respect to the cylindrical channel and sleeve over the operational range of positions to implement the locking or unlocking action. Also, in some embodiments, a first keying pattern that defines characteristics of the grooves cut into the blade of the control key may be different from a second keying pattern that defines characteristics of the grooves cut into each blade of the one or more narrow-blade keys. The first keying pattern may further define characteristics of the first set of outer pin segments, and the second keying pattern may further define characteristics of the second set of outer pin segments.

In some embodiments, the lock assembly may further include a set of middle pin segments arranged in one or more of the first plurality of apertures of the first chamber, the second plurality of apertures of the second chamber, the multiple apertures of the sleeve, and the set of apertures of the plug. In the first fixed position, the set of middle pin segments may be aligned with and arranged between the first set of outer pin segments and the set of inner pin segments. In the second fixed position, the set of middle pin segments may be aligned with and arranged between the second set of outer pin segments and the set of inner pin segments. Also, one or more pin segments of the set of middle pin segments may include a length that is different from a radial distance between the first shear line and the second shear line.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a perspective view of a lock assembly in accordance with an embodiment of the present disclosure;

FIG. 2 is a top view of a lock assembly shown in FIG. 1 in accordance with an embodiment of the present disclosure;

FIG. 3 is a bottom view of a lock assembly shown in FIG. 1 in accordance with an embodiment of the present disclosure;

FIG. 4 is a right side view of a lock assembly shown in FIG. 1 in accordance with an embodiment of the present disclosure;

FIG. 5 is a left side view of a lock assembly shown in FIG. 1 in accordance with an embodiment of the present disclosure;

FIG. 6 is a front view of a lock assembly shown in FIG. 1 in accordance with an embodiment of the present disclosure;

FIG. 7 is a rear view of a lock assembly shown in FIG. 1 in accordance with an embodiment of the present disclosure;

FIG. 8 is a right perspective, exploded view of a lock assembly shown in FIG. 1 in accordance with an embodiment of the present disclosure;

FIG. 9 is a left perspective, exploded view of a lock assembly shown in FIG. 1 in accordance with an embodiment of the present disclosure;

FIG. 10A-10C illustrate various views of a cam adapter in accordance with an embodiment of the present disclosure;

FIG. 11 is a left perspective view of a sleeve in accordance with an embodiment of the present disclosure;

FIG. 12A is a side view of a plug in accordance with an embodiment of the present disclosure;

FIGS. 12B-12D illustrate various views of a rear end of a plug in accordance with an embodiment of the present disclosure;

FIG. 13 illustrates a frontal cross section of the lock assembly in accordance with an embodiment of the present disclosure;

FIG. 14 illustrates a frontal cross section of the lock assembly's restricting chamber in accordance with an embodiment of the present disclosure;

FIGS. 15A and 15B illustrate various shear lines of the lock assembly in accordance with an embodiment of the preset disclosure;

FIGS. 16A-16D illustrate various shear lines and pinning details of the lock assembly in accordance with an embodiment of the preset disclosure;

FIG. 17A-17C illustrate various views of a sleeve in accordance with another embodiment of the present disclosure; and

FIG. 18 is a front view of a housing in accordance with another embodiment of the present disclosure.

It should be understood that the drawings are for purposes of illustrating the concepts of the disclosure and are not necessarily the only possible configuration for illustrating the disclosure. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as not to unnecessarily obscure the embodiment.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail. The word “exemplary” is used herein to mean “serving as an example, instance, or illustration.” Any configuration or design described herein as “exemplary” is not necessarily to be construed as preferred or advantageous over other configurations or designs. Herein, the phrase “coupled” is defined to mean directly connected to or indirectly connected with through one or more intermediate components.

The present disclosure describes various embodiments of locks, locking assemblies, cylinder lock assemblies, and the like. Generally, a lock assembly, as described in the present disclosure, includes a housing having a cylindrical channel, a first plurality of apertures extending from the cylindrical channel to an outer surface of the housing, and a second plurality of apertures extending from the cylindrical channel to the outer surface of the housing. Also, the lock assembly includes a sleeve having a hollow interior and multiple apertures extending from the hollow interior to an outer surface of the sleeve. In particular, the sleeve is rotatably arranged within the cylindrical channel of the housing, wherein a first shear line is defined by an intersection between the outer surface of the sleeve and an inner surface of the cylindrical channel. Furthermore, the lock assembly includes a plug having a keyway and a set of apertures extending from the keyway to an outer surface of the plug. In particular, the plug is rotatably arranged within the hollow interior of the sleeve, wherein a second shear line is defined by an intersection between the outer surface of the plug and an inner surface of the sleeve.

Furthermore, the lock assembly in general may include a first set of outer pin segments configured for reciprocating movement within the first plurality of apertures of the housing. Also, a second set of outer pin segments may be configured for reciprocating movement within the second plurality of apertures of the housing. A set of inner pin segments may be configured for reciprocating movement within the set of apertures of the plug. In a first fixed position, the set of inner pin segments may be substantially aligned with the first set of outer pin segments. In a second fixed position, the set of inner pin segments may be substantially aligned with the second set of outer pin segments. In an operational range of positions, the set of inner pin segments may be rotated with respect to the second set of outer pin segments to implement a locking or unlocking action. The keyway may be configured in particular to accommodate a first key and a second key. The first key, for example, may be a control key configured to rotate the sleeve and plug from the first fixed position to the second fixed position. Also, the second key may be configured to rotate the plug over the operational range of positions to implement the locking or unlocking action.

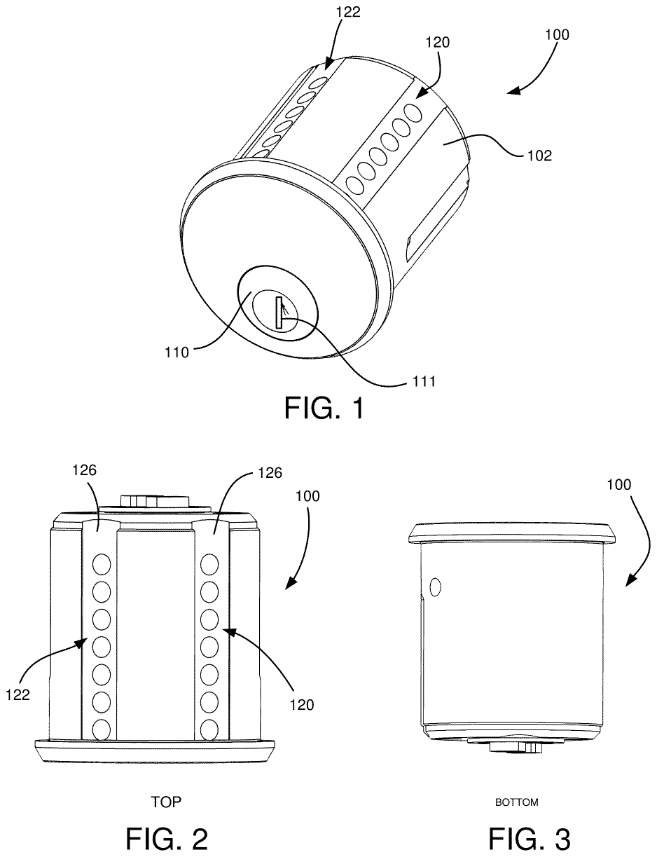

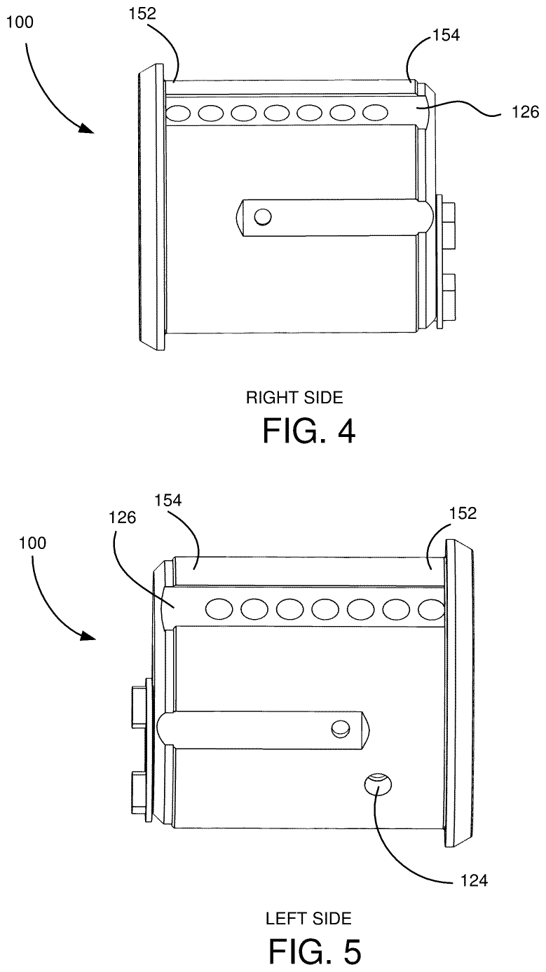

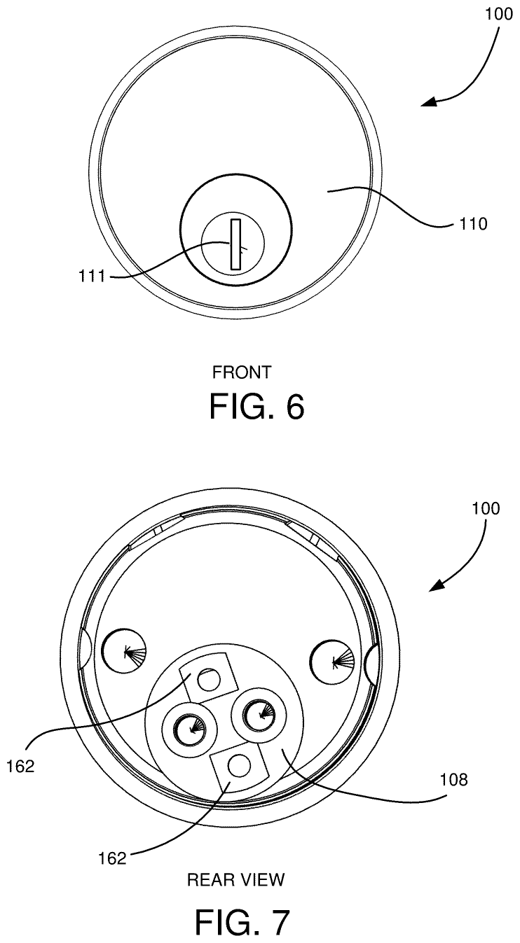

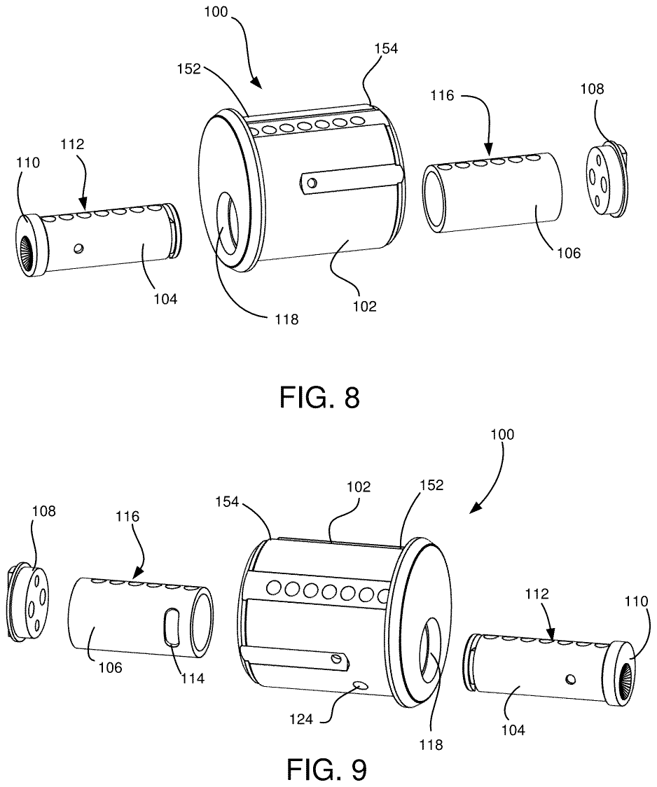

Referring to FIGS. 1-7, a lock assembly 100 (or “cylinder lock assembly”) is provided in accordance with an embodiment of the present disclosure. Referring to FIGS. 8 and 9, an exploded view of the lock assembly 100 is illustrated. The lock assembly 100 includes four parts: a body or housing 102, a plug 104, a sleeve 106, and a cam adapter 108. Pins and springs (not shown in FIGS. 1-9) are disposed in the housing 102 to interact with the plug 104 and the sleeve 106, the details of which are described below. The plug 104 utilizes a keyway 111 for the main cut therethrough. Similarly, the housing 102 may utilize threading along a main outer surface thereof so that the housing 102 can be installed into an existing door or the like. The lock assembly 100 shown in the illustrations may be a 7-pin lock, although the number of holes (i.e., apertures) and pins can vary in other embodiments.

The lock assembly 100 of the present disclosure is generally configured such that two different keys are used sequentially in order to fully unlock (or lock). The first key is known as a “control key” and is responsible for turning the plug 104 and the sleeve 106 (with respect to a channel 118 of the housing 102) between two different states. The two different states of the lock may be referred to as “closed” (e.g., deactivated, disabled, disengaged, etc.) and “opened” (e.g., activated, enabled, engaged, etc.). When positioned in the closed state, only the control key can be used to turn the plug 104 and sleeve 106 (e.g., about 45 degrees clockwise) to the opened position. When positioned in the opened state, the control key may be turned (e.g., about 45 degrees counterclockwise) to the closed position or, alternatively, the second key may be used. The second key is configured to be used for unlocking and locking the lock when the lock is in the opened position.

There are a variety of applications for the lock assembly 100 of the present disclosure. For example, the lock assembly 100 can be used for either high-security or low-security uses due to its size and complexity. In one example, a first (control) key may be given to a supervisor, superintendent, building manager, etc., allowing this person to enable or disable the lock (e.g., configure the lock in the opened or closed state) for various tenants or occupants. For example, a supervisor may wish to restrict usage of the locks for employees during nonoperational hours. The lock assembly 100 of the present disclosure may replace existing Mortise Cylinder housings and function without the need for special installation.

Details of the housing 102, for example, are shown in and described with respect to FIGS. 1-9. Details of the plug 104, for example, are shown in and described with respect to FIGS. 1, 6, 8, 9, 12A-12D. Details of the sleeve 106, for example, are shown in and described with respect to FIGS. 8, 9, and 11. Details of the cam adapter 108, for example, are shown in and described with respect to FIGS. 7-9 and 10A-10C.

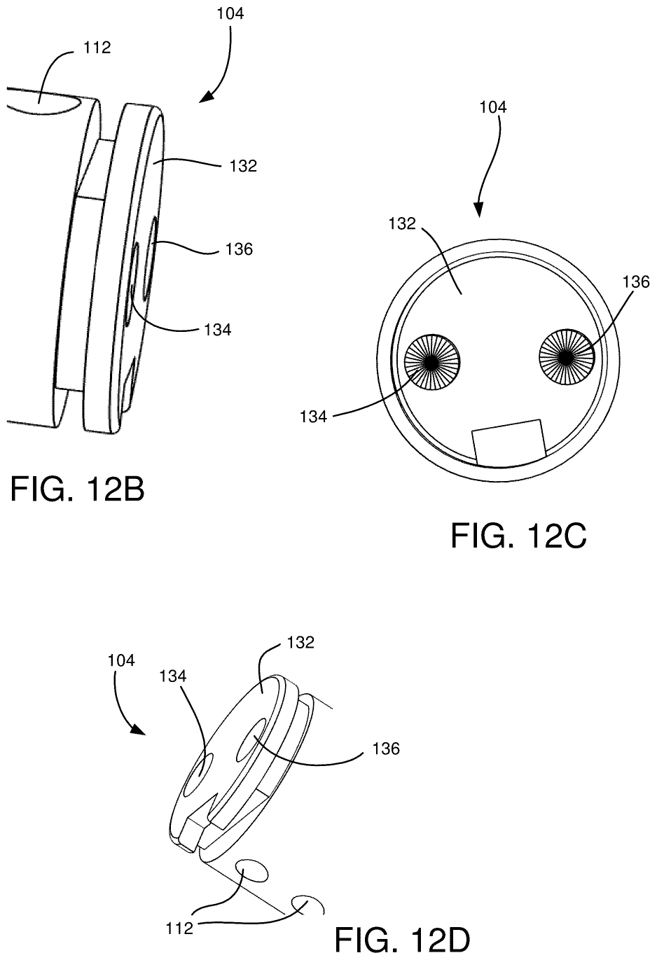

Referring to FIGS. 12A-12B, the plug 104 includes a generally cylindrical body 130 and a generally disc-shaped face section 110 which has a larger diameter than a diameter of the body 130 which secures the plug 104 within the housing 102 so the plug 104 does not fall out of the back of the sleeve 106. The plug 104 has a first end 113 (front end) and a second end 115 (rear end). The first end 113 includes the keyway 111 (FIG. 1) configured to receive at least one key (e.g., control key and tenant key).

As shown in FIGS. 8 and 9, the plug 104 includes a plurality of apertures 112 linearly arranged from the first end 113 of the plug 104 to the second end 115 of the plug 104. The plurality of apertures 112 correspond to channels extending from the keyway 111 to an outer surface of the plug 104. The apertures 112 (and channels) of the plug 104 may be arranged substantially in a row (e.g., within a plane), wherein the channels allow movement of pins therein such that top portions of the pins can extend out through the plurality of apertures 112. In this way, the top portions of the pins can contact corresponding outer pins and/or middle-oriented pins configured in a linear fashion.

A rear surface 132 of the plug 104 (FIGS. 12B-12D) includes a first hole 134 and a second hole 136 (e.g., screw holes) configured to receive a fastener such as a screw or the like to couple the cam adapter 108 to the plug 104.

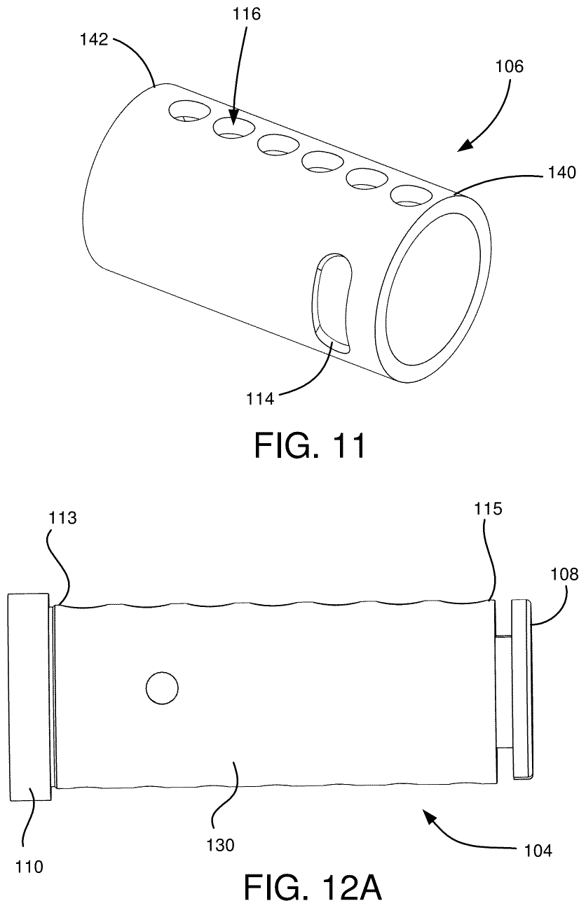

Referring to FIG. 11, the plug 104 is rotatably arranged within the sleeve 106, which includes a hollow cylinder with a unique groove or slot 114 that is positioned on the left side of the sleeve 106. The sleeve 106 has a first end 140 (e.g., front end) and a second end 142 (e.g., rear end). The sleeve 106 includes a plurality of apertures 116 (holes) linearly arranged from the first end 140 of the sleeve 106 to the second end 142 of the sleeve 106. The slot 114 is disposed circumferentially along an outer surface of the sleeve 106 between the first end 140 of the sleeve 106 and the second end 142 of the sleeve 106. The slot 114 receives a pin (not shown) which limits rotation of the sleeve 106 to a predetermined angle with respect to the channel 118 of the housing 102 in which the sleeve is arranged. Although the figures show a predetermined angle of rotation as 45 degrees, it should be noted that other angles are considered to be within the scope of the present disclosure (e.g., 60 degrees, 90 degrees, etc.). The row of apertures 116 along a length of the sleeve 106 is configured for receiving the inner pins, middle-range pins, and/or outer pins extending through the apertures 112 of the plug 104 and apertures 122, 120 of the housing 102.

The housing 102 is the outermost part of the lock assembly 100 and is employed to house the other components and ensure the components can rotate appropriately to enable the transition of the lock assembly 100 from the “closed” state to the “opened” state using the first (control) key. Also, the housing 102 is configured to ensure the components maintained therein can also rotate appropriately to enable a second (tenant) key to be used to lock or unlock the lock assembly 100, such as by rotating the plug 104 with respect to the housing 102 and sleeve 106 from the opened state. The housing 102 may be substantially cylindrical and may include threaded features to fit into existing housings, doors, etc. In may be noted that other shapes of the housing 102 are contemplated to be within the scope of the present disclosure.

The generally cylindrical housing 102 includes a first end 152 and a second end 154. The channel 118 extends from the first end 152 of the housing 102 to the second end 154 of the housing 102. The channel 118 is located below the center of the longitudinal axis that goes through the housing 102 and is configured to receive the plug 104 and sleeve 106. A first plurality of apertures 122 radially extend from the channel 118 to an outer surface of the housing 102 and a second plurality of apertures 120 radially extend from the channel 118 to the outer surface of the housing 102. The first plurality of apertures 122 are linearly arranged from the first end 152 to the second end 154 in a first chamber and the second plurality of apertures 120 are linearly arranged from the first end 152 to the second end 154 in a second chamber. The first and second chambers are positioned 45 degrees apart. It is to be appreciated that the angle between the rows of apertures 120, 122 are substantially equal to the predetermined angle used to configure the slot 114 of sleeve 106.

In addition to the apertures 120, 122 (e.g., pin holes), a single hole 124 is positioned on the side of the housing 102 that is used to house the sleeve's rotation-restricting pin as described above. This hole 124 is located between the second and third pin hole from the first end 152 of the body (e.g., on the left side of the housing 102). The outer surface of the housing 102 along the two rows of apertures 120, 122 may have a dovetail cut 126 to allow a capping strip to slide in and keep the springs and pins inside the chambers or holes.

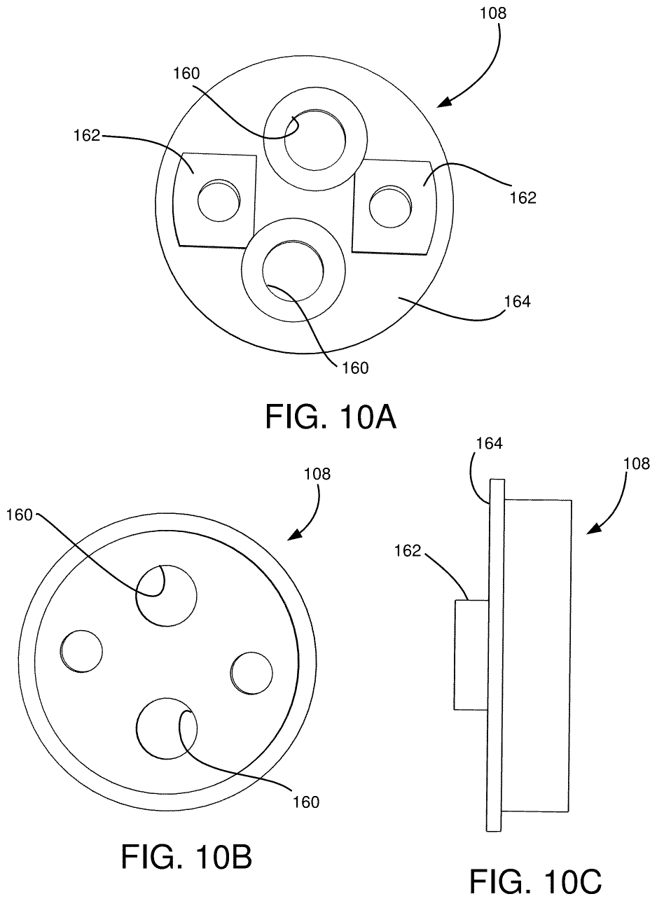

Referring to FIGS. 10A-10C, the cam adapter 108 includes two apertures 160 that are configured to receive fasteners that couple the cam adapter 108 to the rear surface 132 of the plug 104. When screwed into the plug 104, the cam adapter 108 is unable to fall out through the front or back due to its large radius and connection to the plug 104. Additionally, the cam adapter 108 includes two cams 162 that extend from surface 164. The purpose of the cam adapter 108 may be to install a cam onto the plug 104 which would be used to function the door or what the lock assembly 100 is installed in, e.g., the cams 162 may interface with a bolt for opening and/or closing a structure.

Referring to FIGS. 8 and 9, a method of assembling the lock assembly 100 will be described. Initially, the sleeve 106 is inserted into channel 118 of housing 102 via the second end 154 of the body. It is to be appreciated that the sleeve 106 may be rotated in the housing 102 until the slot 114 of the sleeve 106 at least partially aligns with the hole 124 of the housing 102. A pin (not shown) is inserted into the hole 124 to extend into the slot or slot 114.

Next, the plug 104 is inserted into the channel 118 of the housing 102 via the first end 152. The cam adapter 108 is then coupled to the rear surface 132 of the plug 104. Due to the size of the face section 110 of the plug 104 and the cam adapter 108, the plug 104 and sleeve 106 will be retained within the housing 102.

The specific “keying” or “pinning” pattern (e.g., the manner in which the blades of the keys are cut), which is configured to correspond to the lengths of the various pin segments. For example, various pin segments may include the upper pin segments arranged in the apertures 122, 120 of the housing, the lower pin segments arranged in the apertures 112 and channels of the plug 104, and/or any middle pin segments between the upper and lower pin segments. Also, the two sets of pin segments (e.g., associated with the first and second chambers of the first and second pluralities of apertures 122, 120) are configured with “shear lines” have different heights and used inside of the lock assembly 100 to allow the two keys to be cut differently and operate in one of two modes. For example, a first mode enables the transition between the “closed” and “opened” states, while the second mode enables the locking and unlocking actions from the opened state. Also, the “shear lines” are areas where two parts that can rotate independently meet.

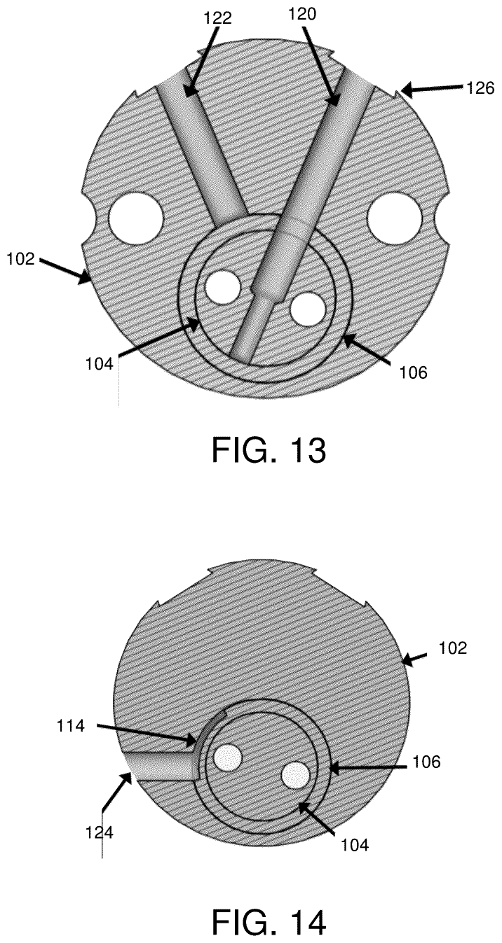

Referring to FIGS. 13, 14, 15A, and 15B, the lock assembly 100 of the present disclosure has two shear lines. One shear line (e.g., inner shear line with smaller radius) is located between the outer surface of the plug 104 and an inner surface of the sleeve 106 and is shown as “Shear Line 1.” The other shear line “Shear Line 2” is located between the outer surface of the sleeve 106 and an inner surface of the channel 118 of the body or housing 102 and has a larger radius. These two shear lines allow the two keys to rotate different parts based on keying or pinning. Both rows of apertures 122, 120 (also known as chambers) are pinned differently from each other and in such a way that the keys function either the plug 104 or the sleeve 106. The pins used in each hole along both rows of apertures 120,122 are not limited to a single combination. Similarly, the cuts of the keys are not limited to a single combination.

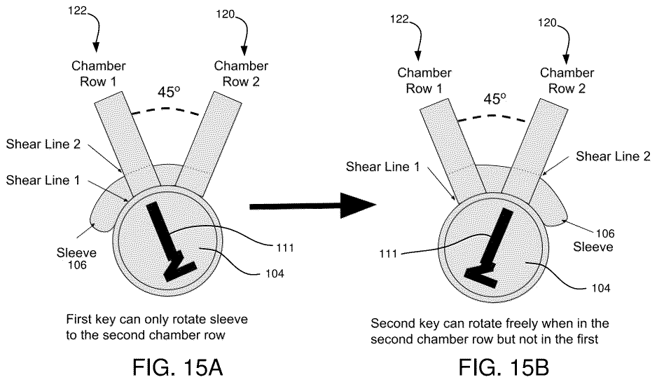

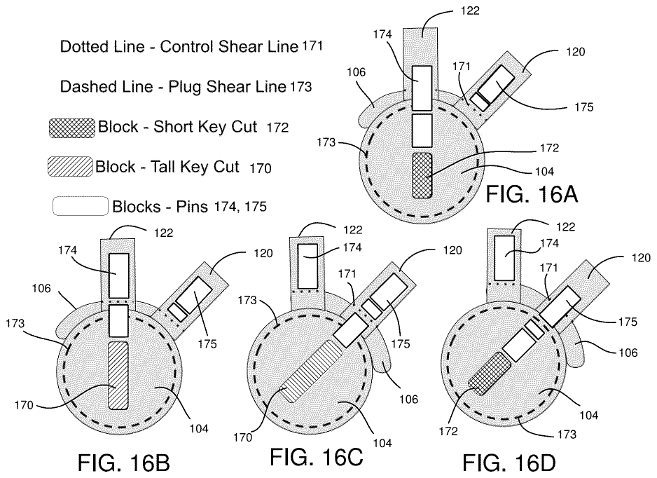

The pinning at the first location (i.e., chamber associated apertures 122) does not allow the use of the second key 172 (e.g., key or keys with a narrower blade or “short cut”). The blade for the second key 172 is narrower in order to more easily configure the pins for alignment with Shear Line 1 having a smaller radius. This embodiment can be used because the pins 174, 175 do not align on either shear line (FIG. 16A). The control key 170 allows the pins 174 to align with the sleeve shear line (Control Shear Line 171) at the chamber associated with apertures 122 and allows rotation to the second location (i.e., chamber associated with apertures 120) (FIGS. 16B-16C). When at that location, the second key 172 can then rotate the plug freely (from the sleeve and housing) because the pins 175 are different and align at the Plug Shear Line 173 (FIG. 16D). In FIGS. 15A and 15B, the first key refers to the control key, shear line 1 is the plug shear line, and shear line 2 is the sleeve shear line. In FIGS. 16A-16D, the Control Shear Line 171 is the sleeve shear line for use with respect to the first key (e.g., control key having a larger radius, “tall cut”), while the Plug Shear Line 173 is the plug shear line for use with respect to the second key 172 (e.g., “short key” cut).

Therefore, according to various embodiments of the present disclosure, the lock assembly 100 may include the housing 102 having a cylindrical channel (e.g., channel 118) extending therethrough, a first chamber extending from the cylindrical channel to an outer surface of the housing 102, and a second chamber extending from the cylindrical channel to the outer surface of the housing 102 (FIG. 1). The first chamber includes the first plurality of apertures 122, and the second chamber includes the second plurality of apertures 120. The lock assembly 100 further includes the sleeve 106 arranged within the cylindrical channel of the housing 102 and configured to be rotatable with respect to the cylindrical channel. A first shear line (Control Shear Line 171) is defined by an intersection between an outer surface of the sleeve 106 and an inner surface of the cylindrical channel. The sleeve 106 further includes a hollow interior and multiple apertures 116 extending from the hollow interior to the outer surface of the sleeve 106. Furthermore, the lock assembly 100 includes the plug 104 arranged in the hollow interior of the sleeve 106 and configured to be rotatable with respect to the sleeve 106. A second shear line (Plug Shear Line 173) is defined by an intersection between an outer surface of the plug 104 and an inner surface of the sleeve 106. The plug 104 further comprises a single keyway 111 configured to accommodate multiple keys and a set of apertures 112 extending from the single keyway 111 to the outer surface of the plug 104.

As shown in FIGS. 16A-16D, a first set of outer pin segments are arranged in the first plurality of apertures 122 of the first chamber of the housing 102 and a second set of outer pin segments are arranged in the second plurality of apertures 120 of the second chamber of the housing 102. Another set of inner pin segments are arranged in the set of apertures 112 of the plug 104. In a first fixed position (e.g., corresponding to the “closed” state), the set of inner pin segments are aligned with the first set of outer pin segments. In a second fixed position (e.g., corresponding to the “opened” state), the set of inner pin segments are aligned with the second set of outer pin segments. In an operational range of positions, the set of inner pin segments can then be further rotated (e.g., from the original opened state as shown in FIG. 16D) with respect to the second set of outer pin segments to implement a locking or unlocking action.

According to some embodiments of the lock assembly 100, the housing 102 may include a generally cylindrical shape, the first end 152, and the second end 154, wherein the cylindrical channel extends from the first end 152 to the second end 154. The first plurality of apertures 122 of the first chamber radially extend from the cylindrical channel to the outer surface of the housing 102, and the second plurality of apertures 120 of the second chamber radially extend from the cylindrical channel to the outer surface of the housing 102. The apertures of the first plurality of apertures 122 are arranged in parallel and in a planar fashion in the first chamber from the first end 152 to the second end 154 of the housing 102, and the apertures of the second plurality of apertures 120 are arranged in parallel and in a planar fashion in the second chamber from the first end 152 to the second end 154 of the housing 102.

Furthermore, the lock assembly 100 may be configured wherein the multiple apertures 116 of the sleeve 106 are arranged linearly from the first end 140 of the sleeve 106 to the second end 142 of the sleeve 106. Also, the set of apertures 112 of the plug 104 may be arranged in parallel and in a planar fashion from the first end 113 of the plug 104 to the second end 115 of the plug 104. Also, the lock assembly 100 further comprises the cam adapter 108 which may be coupled to a rear end of the plug 104, wherein the cam adapter 108 may include at least one cam configured to interact with a bolt (or the like) for implementing the locking or unlocking action. The cylindrical channel in the housing 102 may be offset from a cylindrical axis of the housing 102, and the single keyway 111 in the plug 104 may be offset from a cylindrical axis of the plug 104.

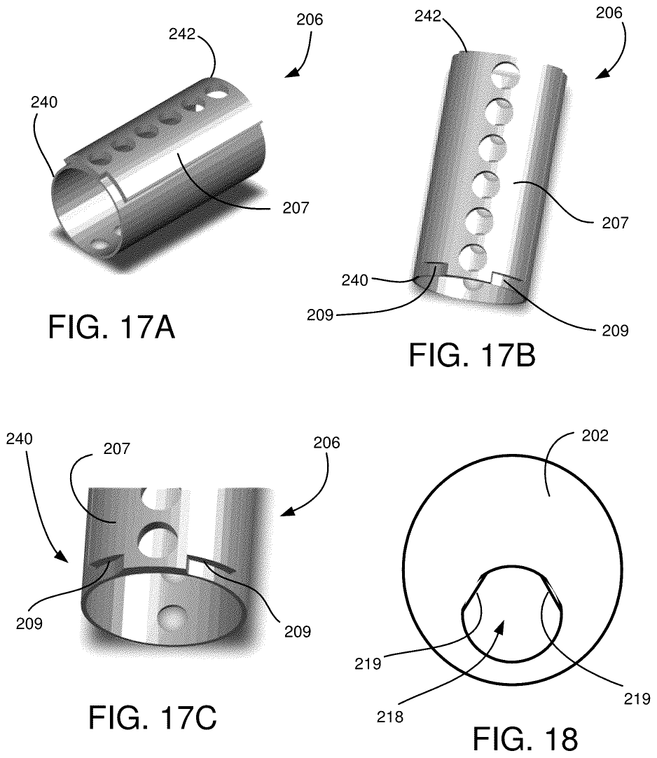

The sleeve 106, for example, may be rotatable within the cylindrical channel by a predetermined angular range (e.g., about 45 degrees). In some embodiments, the sleeve 106 may further include the slot 114, which may be configured to be engaged with a pin extending inwardly from the inner surface of the cylindrical channel of the housing 102. The physical dimensions of the slot 114 and pin, for instance, may define the predetermined angular range. As shown in FIGS. 17A-17C and 18, the cylindrical channel of the housing 102, according to some embodiments, may include a plurality of slanted walls, and the sleeve 106 includes a plurality of recesses on a first end of the sleeve. An interaction of the plurality of recesses and the plurality of slanted walls limits the rotation of the sleeve.

According to additional implementations as described in the present disclosure, the first set of outer pin segments and the set of inner pin segments may be configured in coordination with grooves cut into a blade of a control key, such that, when the control key is inserted in the single keyway, the first shear line becomes unobstructed thereby allowing the sleeve and plug to rotate with respect to the cylindrical channel between the first fixed position and the second fixed position. The second set of outer pin segments and the set of inner pin segments may also be configured in coordination with grooves cut into a blade of each of one or more narrow-blade keys, such that, when a key of the one or more narrow-blade keys is inserted in the single keyway, the second shear line becomes unobstructed thereby allowing the plug to rotate with respect to the cylindrical channel and sleeve over the operational range of positions to implement the locking or unlocking action. A first keying pattern that defines characteristics of the grooves cut into the blade of the control key may be different from a second keying pattern that defines characteristics of the grooves cut into each blade of the one or more narrow-blade keys. The first keying pattern may further define characteristics of the first set of outer pin segments, and the second keying pattern may further define characteristics of the second set of outer pin segments.

In some embodiments, the lock assembly 100 may further comprise a set of middle pin segments arranged in one or more of the first plurality of apertures 122 of the first chamber, the second plurality of apertures 120 of the second chamber, the multiple apertures 116 of the sleeve 106, and the set of apertures 112 of the plug 104. In the first fixed position, the set of middle pin segments are substantially aligned with and arranged between the first set of outer pin segments and the set of inner pin segments. In the second fixed position, the set of middle pin segments are substantially aligned with and arranged between the second set of outer pin segments and the set of inner pin segments. One or more pin segments of the set of middle pin segments, for example, may include a length that is different from a radial distance between the Control Shear Line 171 and the Plug Shear Line 173.

The functioning of the lock assembly 100 of the present disclosure will now be described. As shown in FIG. 16A, if the second key is inserted in the keyway 111, the lock assembly 100 will not operate. Next, a first key is inserted, i.e., a control key, into the keyhole 111 of the plug 104. The pins inside the left row of apertures 122, i.e., the first chamber, line up with the shear line above the sleeve 106, see FIG. 16B. The plug 104 and sleeve 106 can only rotate about 45 degrees clockwise while using the control key, see FIG. 16C. Due to the second row of apertures 120, i.e., the second chamber, containing different pins (or the same internal pins, but different external and intermediate pins), the second key is able to line the pins up with the shear line above the plug 104, as shown in FIG. 16D. The plug 104 can rotate freely using this second key, i.e., the second key may control the plug 104 and cam adapter 108 to open and/or close a bolt.

Using the first key to rotate 45 degrees counterclockwise resets the lock assembly to the initial position where the second key cannot be used (e.g., essentially disabled), as shown in FIG. 16A. The second key is unusable until the control key transitions the lock to the “opened” or enabled state. FIGS. 16B-16D show the movement of the various parts of the pins, as controlled by the keying pattern of the various keys. Again, when the pin intersections align with the shear lines, the plug and/or sleeve can rotate. When the control key 170 with appropriately keyed grooves is used to enable movement, the sleeve and plug can move together from the first state (FIG. 16B) to the second state (FIG. 16C). Then, the second key 172 (e.g., low-profile, narrow blade, or “short cut” key) can be used to control the pin segments that allow the plug to rotate farther, independent of the sleeve, to enable the locking or unlocking actions.

Again, each pin has an outer pin segment, an inner pin segment, and a middle pin segment. The middle pin segment may be the same or different size as the radial offset distance between the two shear lines. In some embodiments, the middle pin segments may be optional. Also, the control key may be used for a first set of locks or locking assemblies in multiple doors. Each of the second keys could then be configured for one specific lock of this set to be used by individuals for their specific door. A supervisor might engage each lock in a specific area and then each tenant may use their own key just for their door. To disengage the lock (or lock out a tenant), the supervisor would have to use a copy of the second key to rotate back to the position for alignment with the apertures 120 (e.g., the opened state) and then use the control key to rotate the lock back to the position for alignment with the apertures 122 (e.g., the closed state). Then, the tenant could not use their second key to get back in without the supervisor using their control key.

While the disclosure has been shown and described with reference to certain preferred embodiments thereof, it will be understood by those skilled in the art that various changes in form and detail may be made therein without departing from the spirit and scope of the disclosure.

For example, modifications to the above-described embodiments may be made to limit the rotation of the plug by providing an alternate sleeve and housing as shown in FIGS. 17A-17C and 18. FIGS. 17A-17C illustrate an embodiment of a sleeve 206 having a first end 240 and second end 242. A raised portion 207 extends above an outer surface of the sleeve 206 from the first end 240 to the second end 242. Recesses 209 are formed in the raised portion 207 at the first end 240 along the edge of the sleeve 206. Referring to FIG. 18, housing 202 includes channel 218. In this embodiment, channel 218 is not perfectly cylindrical but includes slanted walls 219. The recesses 209 interact with the slanted walls 219 of channel 218 to limit the rotation of the sleeve 206 to 45 degrees, i.e., between the two chambers of pins. It is to be appreciated that the slanted walls 219 may be modified to achieve other angles of rotation.

There are a variety of applications for this type of lock other than high security purposes. An owner of a company may use this lock to restrict access to employees during specific times. If the owner has the lock in the closed position, then no one is able to access it other than the owner since they would have both keys. When the lock is in the open position, then both the owner and employees can access it while anyone without a key still cannot. The lock adds an extra layer of security for many of these types of situations while still possibly retaining standard lock dimensions.

Compared to other locks that share a similar purpose, this lock is more compact and complex. The lock on a safety deposit box is much larger and utilizes two key holes in order for both keys to function the lock. This lock can possibly be installed into existing doors that already have Mortise Cylinder housings. It is also within the contemplation of the present disclosure to employ the novel lock assembly with conventional lock and bolt assemblies. That is, the cam adapter 108 may include any suitable design and construction so as to accommodate various types of dead bolt locking mechanisms, such as in a well-known manner. Mortise, cam, and switch lock constructions are also contemplated. The lock can be used for both high-security uses as well as low-security uses due to its complexity, size, and ease of installation.

It is to be appreciated that the various features shown and described are interchangeable, that is a feature shown in one embodiment may be incorporated into another embodiment.

Furthermore, although the foregoing text sets forth a detailed description of numerous embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

What is claimed is:

1. A lock assembly comprising:
a housing having a cylindrical channel extending therethrough, a first chamber extending from the cylindrical channel to an outer surface of the housing, and a second chamber extending from the cylindrical channel to the outer surface of the housing, wherein the first chamber includes a first plurality of apertures, and wherein the second chamber includes a second plurality of apertures;
a sleeve arranged within the cylindrical channel of the housing and configured to be rotatable with respect to the cylindrical channel, wherein a first shear line is defined by an intersection between an outer surface of the sleeve and an inner surface of the cylindrical channel, and wherein the sleeve further includes a hollow interior and multiple apertures extending from the hollow interior to the outer surface of the sleeve;
a plug arranged in the hollow interior of the sleeve and configured to be rotatable with respect to the sleeve, wherein a second shear line is defined by an intersection between an outer surface of the plug and an inner surface of the sleeve, and wherein the plug further comprising a single keyway configured to accommodate multiple keys and a set of apertures extending from the single keyway to the outer surface of the plug;
a first set of outer pin segments arranged in the first plurality of apertures of the first chamber of the housing;
a second set of outer pin segments arranged in the second plurality of apertures of the second chamber of the housing; and
a set of inner pin segments arranged in the set of apertures of the plug;
wherein, in a first fixed position, the set of inner pin segments are aligned with the first set of outer pin segments,
wherein, in a second fixed position, the set of inner pin segments are aligned with the second set of outer pin segments, and
wherein, in an operational range of positions, the set of inner pin segments are rotated with respect to the second set of outer pin segments to implement a locking or unlocking action.

2. The lock assembly of claim 1, wherein the housing includes a generally cylindrical shape, a first end, and a second end, wherein the cylindrical channel extends from the first end of the housing to the second end of the housing, wherein the first plurality of apertures of the first chamber radially extend from the cylindrical channel to the outer surface of the housing, and wherein the second plurality of apertures of the second chamber radially extend from the cylindrical channel to the outer surface of the housing.

3. The lock assembly of claim 1, wherein apertures of the first plurality of apertures are arranged in parallel and in a planar fashion in the first chamber from a first end to a second end of the housing, and wherein apertures of the second plurality of apertures are arranged in parallel and in a planar fashion in the second chamber from a first end to a second end of the housing.

4. The lock assembly of claim 1, wherein the multiple apertures of the sleeve are arranged linearly from a first end of the sleeve to a second end of the sleeve, and wherein the set of apertures of the plug are arranged in parallel and in a planar fashion from a first end of the plug to a second end of the plug.

5. The lock assembly of claim 1, further comprising a cam adapter coupled to a rear end of the plug, wherein the cam adapter includes at least one cam configured to interact with a bolt for implementing the locking or unlocking action.

6. The lock assembly of claim 1, wherein the sleeve is rotatable within the cylindrical channel by a predetermined angular range.

7. The lock assembly of claim 6, wherein the predetermined angular range is about 45 degrees.

8. The lock assembly of claim 6, wherein the sleeve further includes a slot configured to be engaged with a pin extending inwardly from the inner surface of the cylindrical channel of the housing, and wherein physical dimensions of the slot and pin define the predetermined angular range.

9. The lock assembly of claim 6, wherein the cylindrical channel of the housing includes a plurality of slanted walls, and the sleeve includes a plurality of recesses on a first end of the sleeve, and wherein an interaction of the plurality of recesses and the plurality of slanted walls limits rotation of the sleeve.

10. The lock assembly of claim 1, wherein the first set of outer pin segments and the set of inner pin segments are configured in coordination with grooves cut into a blade of a control key, such that, when the control key is inserted in the single keyway, the first shear line becomes unobstructed thereby allowing the sleeve and plug to rotate with respect to the cylindrical channel between the first fixed position and the second fixed position.

11. The lock assembly of claim 10, wherein the second set of outer pin segments and the set of inner pin segments are configured in coordination with grooves cut into a blade of each of one or more narrow-blade keys, such that, when a key of the one or more narrow-blade keys is inserted in the single keyway, the second shear line becomes unobstructed thereby allowing the plug to rotate with respect to the cylindrical channel and sleeve over the operational range of positions to implement the locking or unlocking action.

12. The lock assembly of claim 11, wherein a first keying pattern that defines characteristics of the grooves cut into the blade of the control key is different from a second keying pattern that defines characteristics of the grooves cut into each blade of the one or more narrow-blade keys, wherein the first keying pattern further defines characteristics of the first set of outer pin segments, and wherein the second keying pattern further defines characteristics of the second set of outer pin segments.

13. The lock assembly of claim 1, further comprising a set of middle pin segments arranged in one or more of the first plurality of apertures of the first chamber, the second plurality of apertures of the second chamber, the multiple apertures of the sleeve, and the set of apertures of the plug.

14. The lock assembly of claim 13, wherein, in the first fixed position, the set of middle pin segments is aligned with and arranged between the first set of outer pin segments and the set of inner pin segments, and wherein, in the second fixed position, the set of middle pin segments is aligned with and arranged between the second set of outer pin segments and the set of inner pin segments.

15. The lock assembly of claim 13, wherein one or more pin segments of the set of middle pin segments includes a length that is different from a radial distance between the first shear line and the second shear line.

16. The lock assembly of claim 1, wherein the cylindrical channel in the housing is offset from a cylindrical axis of the housing, and wherein the single keyway in the plug is offset from a cylindrical axis of the plug.

17. A lock assembly comprising:
a housing having a cylindrical channel, a first plurality of apertures extending from the cylindrical channel to an outer surface of the housing, and a second plurality of apertures extending from the cylindrical channel to the outer surface of the housing;
a sleeve having a hollow interior and multiple apertures extending from the hollow interior to an outer surface of the sleeve, the sleeve rotatably arranged within the cylindrical channel of the housing, wherein a first shear line is defined by an intersection between the outer surface of the sleeve and an inner surface of the cylindrical channel; and
a plug having a keyway and a set of apertures extending from the keyway to an outer surface of the plug, the plug rotatably arranged within the hollow interior of the sleeve, wherein a second shear line is defined by an intersection between the outer surface of the plug and an inner surface of the sleeve.

18. The lock assembly of claim 17, further comprising:
a first set of outer pin segments configured for reciprocating movement within the first plurality of apertures of the housing;
a second set of outer pin segments configured for reciprocating movement within the second plurality of apertures of the housing; and
a set of inner pin segments configured for reciprocating movement within the set of apertures of the plug.

19. The lock assembly of claim 18, wherein:
in a first fixed position, the set of inner pin segments are aligned with the first set of outer pin segments,
in a second fixed position, the set of inner pin segments are aligned with the second set of outer pin segments, and
in an operational range of positions, the set of inner pin segments are rotated with respect to the second set of outer pin segments to implement a locking or unlocking action.

20. The lock assembly of claim 19, wherein the keyway is configured to accommodate a first key and a second key, wherein the first key is a control key configured to rotate the sleeve and plug from the first fixed position to the second fixed position, and wherein the second key is configured to rotate the plug over the operational range of positions to implement the locking or unlocking action.
